(19) United States
(12) Patent Application Publication
(10) Pub. No.: US 2017/0134698 A1
(43) Pub. Date: May 11, 2017

(54) VIDEO COMPOSITE TECHNIQUES

(71) Applicant: Vivint, Inc, Provo, UT (US)

(72) Inventor: Matthew Mahar, Salt Lake City, UT (US)

(21) Appl. No.: 14/938,569

(22) Filed: Nov. 11, 2015

(51) Int. Cl. H04N 7/18; H04N 5/265; G08B 13/196

(52) U.S. Cl. CPC H04N 7/181; G08B 13/1966; G08B 13/19697; H04N 5/265

(57) ABSTRACT

A method for a security and/or automation system is described. The method may include receiving, from a first camera in a first location, a first video; receiving, from a second camera in a second location, a second video; analyzing at least one of the first video and the second video; and combining the first video and the second video into a composite video based at least in part on the analyzing; an transmitting the composite video.

### BACKGROUND

The present disclosure relates to security and/or automation systems, and more particularly to an automated image capture and splicing method and system.

Security and automation systems are widely deployed to provide various types of communication and functional features such as monitoring, communication, notification, and/or others. These systems may be capable of supporting communication with at least one user through a communication connection or a system management action.

Video surveillance systems record video on a per camera basis, and often include a at least one camera per room. If a person moves from room to room in a house, for example, following the path of the person may require viewing multiple videos and extrapolating information. Additionally, current systems continue to capture video even when it is not needed, creating unnecessary files.

### SUMMARY

The present systems and methods relate generally to combining multiple video files into a single, continuous composite video based at least in part on the movements of a person around and/or within a property. In some embodiments, the person may not be authorized to be on the property, and thus the video composite may be used as a security and/or surveillance tool. The video composite may be used to perform one or more operations, including triggering a status change based on determining whether a person is authorized. In another embodiment, the video composite may be used to track the movements of an authorized person to determine where people are frequently located within a building and/or a specific room, how people move within the building and/or a specific room, and/or which people are most frequently (or less frequently) located in specific locations.

A method for automation and/or security is described. In some embodiments, the method may include receiving, from a first camera in a first location, a first video; receiving, from a second camera in a second location, a second video; analyzing at least one of the first video and the second video; combining the first video and the second video into a composite video based at least in part on the analyzing; and/or transmitting the composite video.

An apparatus for automation and/or security is described. The apparatus may include a processor, memory in electronic communication with the processor, and instructions stored in the memory. In some embodiments, the instructions may cause the processor to receive, from a first camera in a first location, a first video; receive, from a second camera in a second location, a second video; analyze at least one of the first video and the second video; combine the first video and the second video into a composite video based at least in part on the analyzing; and/or transmit the composite video.

A non-transitory computer readable medium for automation and/or security is described. In some embodiments, the non-transitory computer readable medium may store a program that, when executed by a processor, causes the processor to receive, from a first camera in a first location, a first video; receive, from a second camera in a second location, a second video; analyze at least one of the first video and the second video; combine the first video and the second video into a composite video based at least in part on the analyzing; and/or transmit the composite video.

In some embodiments of the method, apparatus, and/or non-transitory computer-readable medium described above, the composite video may be transmitted to a handheld wireless device.

Some embodiments of the method, apparatus, and/or non-transitory computer-readable medium may include processes, features, means, and/or instructions for identifying an alarm status; and/or modifying the alarm status based at least in part on the alarm status and/or determining whether an person is authorized.

Some embodiments of the method, apparatus, and/or non-transitory computer-readable medium may include processes, features, means, and/or instructions for determining a first presence of a person at the first location; determining a second presence of the person at the second location; determining an identification of the person; determining whether the person is authorized to be in the second location; and/or triggering an alarm event based at least in part on determining if the person is authorized to be in the second location.

Some embodiments of the method, apparatus, and/or non-transitory computer-readable medium may include processes, features, means, and/or instructions for determining a presence of a person at the first location; determining whether the person is authorized to be in the first location; and/or requesting approval from a user to perform an operation based at least in part on determining the person is unauthorized to be in the first location.

In some embodiments of the method, apparatus, and/or non-transitory computer-readable medium described, determining whether the person is authorized or unauthorized may include capturing biometric information associated with the person; and/or analyzing the captured biometric information. The embodiments may include determining a time of day; and/or determining whether the person is authorized to be at the first location, the determining based at least in part on the time of day.

In some embodiments of the method, apparatus, and/or non-transitory computer-readable medium described, determining whether the person is authorized or unauthorized may further include capturing biometric information associated with the person; and/or comparing the captured biometric information to a database of authorized people. In some embodiments, capturing biometric information may further include capturing at least one of voice recognition, or facial recognition, or radio frequency identification recognition, or retinal recognition, or fingerprint recognition, or a combination thereof.

Some embodiments of the method, apparatus, and/or non-transitory computer-readable medium may further include processes, features, means, and/or instructions for: determining a relationship between the first location and the second location; and determining that a person has exited the first location and entered the second location.

Some embodiments of the method, apparatus, and/or non-transitory computer-readable medium may further include processes, features, means, and/or instructions for appending a beginning of the second video to an ending of the first video.

Some embodiments of the method, apparatus, and/or non-transitory computer-readable medium may include processes, features, means, and/or instructions for receiving, from a third camera in a third location, a third video, the third location being in outdoor environment; and/or combining the third video with the composite video.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a block diagram relating to a security and/or an automation system, in accordance with various embodiments;

FIG. 2 shows a block diagram of a device relating to a security and/or an automation system, in accordance with various embodiments;

FIG. 3 shows a block diagram of a device relating to a security and/or an automation system, in accordance with various embodiments;

FIG. 4 shows a block diagram relating to a security and/or an automation system, in accordance with various embodiments;

FIG. 5 is a flow chart illustrating an example of a method relating to a security and/or an automation system, in accordance with various embodiments;

FIG. 6 is a flow chart illustrating an example of a method relating to a security and/or an automation system, in accordance with various embodiments; and

FIG. 7 is a flow chart illustrating an example of a method relating to a security and/or an automation system, in accordance with various embodiments.

### DETAILED DESCRIPTION

The present systems and methods relate generally to combining multiple video files into a single, continuous composite video based at least in part on the movements of a person around and/or within a property. In some embodiments, the person may not be authorized to be on the property, and thus the video composite may be used as a security and/or surveillance tool. The video composite may be used to perform one or more operations, including triggering a status change based on determining whether a person is authorized. In another embodiment, the video composite may be used to track the movements of an authorized person to determine where people are frequently located within a building and/or a specific room, how people move within the building and/or a specific room, and/or which people are most frequently (or less frequently) located in specific locations.

The following description provides examples and is not limiting of the scope, applicability, and/or examples set forth in the claims. For example, embodiments may be directed to the home environment, but the disclosure is not limited solely to such a location and may be implemented in any environment including an office building, a school, a commercial location, etc. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

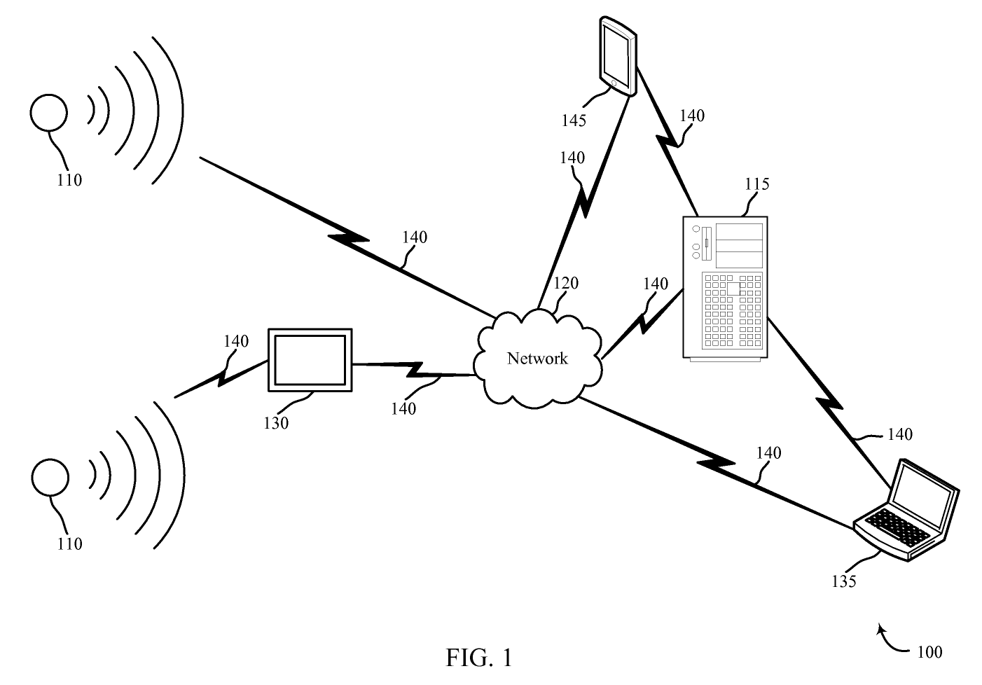

FIG. 1 is an example of a communications system 100 in accordance with various aspects of the disclosure. The communications system 100 may include one or more sensors 110, network 120, server 115, control panel 130, remote computing device 135, and/or local computing device 145. The network 120 may provide user authentication, encryption, access authorization, tracking, Internet Protocol (IP) connectivity, and other access, calculation, modification, and/or functions. The control panel 130 may interface with the network 120 through a first set of wired and/or wireless communication links 140 to communicate with one or more remote servers 115. The control panel 130 may perform communication configuration, adjustment, and/or scheduling for communication with the computing devices 135 and 145, or may operate under the control of a controller. Control panel 130 may communicate with a back end server (such as the remote server 115)—directly and/or indirectly—using the first set of one or more communication links 140.

The control panel 130 may wirelessly communicate with the remote computing device 135 and the local computing device 145 by way of one or more antennas. The control panel 130 may provide communication coverage for a respective geographic coverage area. In some examples, control panel 130 may be referred to as a control device, a base transceiver station, a radio base station, an access point, a radio transceiver, or some other suitable terminology. The geographic coverage area for a control panel 130 may be divided into sectors making up only a portion of the coverage area. The communications system 100 may include a control panel 130 of different types. There may be overlapping geographic coverage areas for one or more different parameters, including different technologies, features, subscriber preferences, hardware, software, technology, and/or methods. For example, each control panel 130 may be related to one or more discrete structures (e.g., a home, a business) and each of the one more discrete structures may be related to one or more discrete areas. In other examples, multiple control panel 130 may be related to the same one or more discrete structures (e.g., multiple control panels relating to a home and/or a business complex).

The computing devices 135 and 145 may be dispersed throughout the communications system 100 and each computing device 135 and 145 may be stationary and/or mobile. Computing devices 135 and 145 may include a cellular phone, a personal digital assistant (PDA), a wireless modem, a wireless communication device, a wearable electronic device, a handheld device, a tablet computer, a laptop computer, a cordless phone, a wireless local loop (WLL) station, a display device (e.g., TVs, computer monitors, etc.), a printer, a camera, and/or the like, among other things. Computing devices 135 and 145 may also include or be referred to by those skilled in the art as a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. The geographic coverage area for the control panel 130 may be divided into sectors making up only a portion of the coverage area. The communication system, therefore, may comprise more than one control panel 130, where each control panel 130 may provide geographic coverage for one or more sectors of the coverage area. The communications system 100 may include one or more control panels 130 of different types. The control panel 130 may be related to one or more discrete areas. Control panel 130 may be a home automation system control panel or a security control panel, for example, an interactive panel located in a user's home. Control panel 130 may be in direct communication by way of wired and/or wireless communication links with the one or more sensors 110. In another embodiment, control panel 130 may receive sensor data from the one or more sensors 110 directly and/or indirectly by way of computing devices 135 and 145, server 115, and wireless communication links 140, among other things.

In one embodiment, the control panel 130 may comprise, but is not limited to, a speaker, a microphone, and/or a camera (e.g., enabled for still capture and/or video capture). The control panel 130 may operate to receive, process, broadcast audio and/or video communications received from computing devices 135 and/or 145. In other embodiments, control panel 130 may receive input in the form of audio data, video data, biometric data, geographic data (e.g. geotagging, global positioning data), some combination, and/or the like. In other embodiment, the control panel 130 itself may operate to broadcast audio and/or video.

The control panel 130 may wirelessly communicate with the sensors 110 via one or more antennas. The sensors 110 may be dispersed throughout the communications system 100 and each sensor 110 may be stationary and/or mobile. A sensor 110 may include and/or be one or more sensors that sense: proximity, motion, temperatures, humidity, sound level, smoke, structural features (e.g., glass breaking, window position, door position), time, amount of light, geo-location data of a user and/or a device, distance, biometrics, weight, speed, height, size, preferences, weather, system performance, vibration, respiration, heartbeat, and/or other inputs that relate to a security and/or an automation system. Computing devices 135 and 145 and/or a sensor 110 may be able to communicate through one or more wired and/or wireless connections with various components such as control panels, base stations, and/or network equipment (e.g., servers, wireless communication points, etc.) and/or the like.

The communication links 140 shown in communications system 100 may include uplink (UL) transmissions from computing devices 135 and/or 145 and/or sensors 110 to a control panel 130, and/or downlink (DL) transmissions, from a control panel 130 to computing devices 135 and/or 145. In some embodiments, the downlink transmissions may also be called forward link transmissions, while the uplink transmissions may also be called reverse link transmissions. Each communication link 140 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links 140 may transmit bidirectional communications and/or unidirectional communications. Communication links 140 may include one or more connections, including but not limited to, 345 MHz, Wi-Fi, BLUETOOTH®, BLUETOOTH® Low Energy, cellular, Z-WAVE®, 802.11, peer-to-peer, LAN, WLAN, Ethernet, fire wire, fiber optic, and/or other connection types related to security and/or automation systems.

In some embodiments, control panel 130 and/or computing devices 135 and 145 may include one or more antennas for employing antenna diversity schemes to improve communication quality and reliability between control panel 130 and computing devices 135 and 145. Additionally or alternatively, control panel 130 and/or computing devices 135 and 145 may employ multiple-input, multiple-output (MIMO) techniques that may take advantage of multi-path, mesh-type environments to transmit multiple spatial layers carrying the same or different coded data.

While the computing devices 135 and/or 145 may communicate with each other through the control panel 130 using communication links 140, each computing device 135 and/or 145 may also communicate directly and/or indirectly with one or more other devices via one or more direct communication links 140. Two or more computing devices 135 and 145 may communicate via a direct communication link 140 when both computing devices 135 and 145 are in the geographic coverage area or when one or neither of the computing devices 135 or 145 is within the geographic coverage area. Examples of direct communication links 140 may include Wi-Fi Direct, BLUETOOTH®, wired, and/or, and other P2P group connections. The computing devices 135 and 145 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within communications system 100.

In one example embodiment, the computing devices 135 and 145 may be a remote computing device and a local computing device, respectively. Local computing device 145 may be a custom computing entity configured to interact with sensors 110 via network 120, and in some embodiments, via server 115. In other embodiments, remote computing device 135 and local computing device 145 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules.

Control panel 130 may be a smart home system panel, for example, an interactive panel mounted on a wall in a user's home. Control panel 130 may be in direct and/or indirect communication via wired or wireless communication links 140 with the one or more sensors 110, or may receive sensor data from the one or more sensors 110 via local computing device 145 and network 120, or may receive data via remote computing device 135, server 115, and network 120.

The computing devices 135 and 145 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the computing devices 135, 145 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensors 110.

The processor of the local computing device 145 may be operable to control operation of the output of the local computing device 145. The output may be a television, a liquid crystal display (LCD) monitor, a cathode ray tube (CRT) monitor, speaker, tactile output device, and/or the like. In some embodiments, the output may be an integral component of the local computing device 145. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing device 145 to the output.

The remote computing device 135 may be a computing entity operable to enable a remote user to monitor the output of the sensors 110. In some embodiments, the remote computing device 135 may be functionally and/or structurally similar to the local computing device 145 and may be operable to receive data files from and/or send signals to at least one of the sensors 110 via the network 120. The network 120 may be the Internet, an intranet, a personal area network, a local area network (LAN), a wide area network (WAN), a virtual network, a telecommunications network implemented as a wired network and/or wireless network, etc. The remote computing device 135 may receive and/or send signals over the network 120 via communication links 140 and server 115.

In some embodiments, one or more sensors 110 may communicate through wired and/or wireless communication links 140 with one or more of the computing devices 135 and 145, the control panel 130, and/or the network 120. The network 120 may communicate through wired and/or wireless communication links 140 with the control panel 130, and/or the computing devices 135 and 145 through server 115. In another embodiment, the network 120 may be integrated with any of the computing devices 135, 145 and/or server 115 such that separate components are not required. Additionally, in another embodiment, one or more sensors 110 may be integrated with control panel 130, and/or control panel 130 may be integrated with local computing device 145 such that separate components are not required.

In some embodiments, the one or more sensors 110 may be sensors configured to conduct periodic and/or ongoing automatic measurements related to determining the identity of a person and/or determining the location of a person within a predetermined area. Each sensor 110 may be capable of sensing multiple identification and/or location determining parameters, or alternatively, separate sensors 110 may monitor separate identification and/or location determining parameters. For example, one sensor 110 may determine the identity of a person, while another sensor 110 (or, in some embodiments, the same sensor 110) may detect the location of the person.

In some embodiments, a local computing device 145 may additionally monitor alternate identification and/or location-determination parameters, such as using heartbeat, respiration, thermal and/or audio sensors. In alternate embodiments, a user may input identification and location data directly at the local computing device 145 or control panel 130. For example, a person may enter identification data into a dedicated application on his smart phone or smart watch indicating that he is located in the living room of his house. The identification and location data may be communicated to the remote computing device 135 accordingly. In addition, a GPS feature integrated with the dedicated application on the person's portable electronic device may communicate the person's location to the remote computing device 135.

Data gathered by the one or more sensors 110 may be communicated to one or more computing devices 135 and/or 145, which may be, in some embodiments, a thermostat or other wall-mounted input/output smart home display. In other embodiments, computing devices 135 and/or 145 may be a personal computer or smart phone. Where computing devices 135 and/or 145 is/are a smart phone, the smart phone may have a dedicated application directed to collecting identity and/or location data, among other things, and performing one or more operations based at least in part on the collected data. The computing device 135 and/or 145 may process the data received from the one or more sensor units 110 in accordance with various aspects of the disclosure. In alternative embodiments, computing device 135 and/or 145 may process the data received from the one or more sensor units 110, via network 125 and server 155 in accordance with various aspects of the disclosure. Data transmission may occur via, for example, frequencies appropriate for a personal area network (such as BLUETOOTH® or IR communications) or local or wide area network frequencies such as radio frequencies specified by the IEEE 802.15.4 standard.

In some embodiments, the one or more sensors 110 may be separate from the control panel 130 and may be positioned at various locations throughout the house or the property. In other embodiments, the one or more sensors 110 may be integrated or collocated with other house and/or building automation system components, home appliances, and/or other building fixtures. For example, a sensor 110 may be integrated with a doorbell or door intercom system, or may be integrated with a front entrance light fixture. In other embodiments, a sensor 110 may be integrated with a wall outlet and/or switch. In other embodiments, the one or more sensors 110 may be integrated and/or collocated with the control panel 130 itself. In any embodiment, each of the one or more sensors 110, control panel 130, and/or local computing device 145 may comprise a speaker unit, a microphone unit, and/or a camera unit, among other things.

In one embodiment, audio and/or video may be broadcast from the remote computing device 135 to the local computing device 145 and/or the control panel 130. The broadcast (whether it be audio and/or video) may be communicated directly to the local computing device 145 or the control panel 130 by way of network 120. In another embodiment, the broadcasts may be communicated first through server 115.

The server 115 may be configured to communicate with the one or more sensors, local computing device 145, the remote computing device 135, and the control panel 130. The server 115 may perform additional processing on signals received from the one or more sensors 110, local computing device 145, and/or control panel 130, and/or may forward the received information to the remote computing device 135. For example, server 115 may receive identification and location data from one or more sensors 110 and may receive a communication request from remote computing device 135. Based on the received identification and location data, the server 115 may direct the received communication request to the appropriate one or more components of the home automation system, such as the control panel 130 and/or local computing device 145. Thus, the home automation system, by way of communications with server 115, may automatically direct incoming audio and video files from a remote caller to the appropriate microphone/speaker/video system in the home in order to enable one-way or two-way communication with other people.

Server 115 may be a computing device operable to receive data files (e.g., from sensors 110 and/or local computing device 145, and/or remote computing device 135), store and/or process data, and/or transmit data and/or data summaries (e.g., to remote computing device 140). For example, server 115 may receive identification data from a sensor 110 and location data from the same and/or a different sensor 110. In some embodiments, server 115 may “pull” the data (e.g., by querying the sensors 110, the local computing device 145, and/or the control panel 130). In some embodiments, the data may be “pushed” from the sensors 110 and/or the local computing device 145 to the server 115. For example, the sensors 110 and/or the local computing device 145 may be configured to transmit data as it is generated by or entered into that device. In some instances, the sensors 110 and/or the local computing device 145 may periodically transmit data (e.g., as a block of data or as one or more data points).

The server 115 may include a database (e.g., in memory) containing location, identification and/or authentication data received from the sensors 110 and/or the local computing device 145. Additionally, as described in further detail herein, software (e.g., stored in memory) may be executed on a processor of the server 115. Such software (executed on the processor) may be operable to cause the server 115 to monitor, process, summarize, present, and/or send a signal associated with resource usage data.

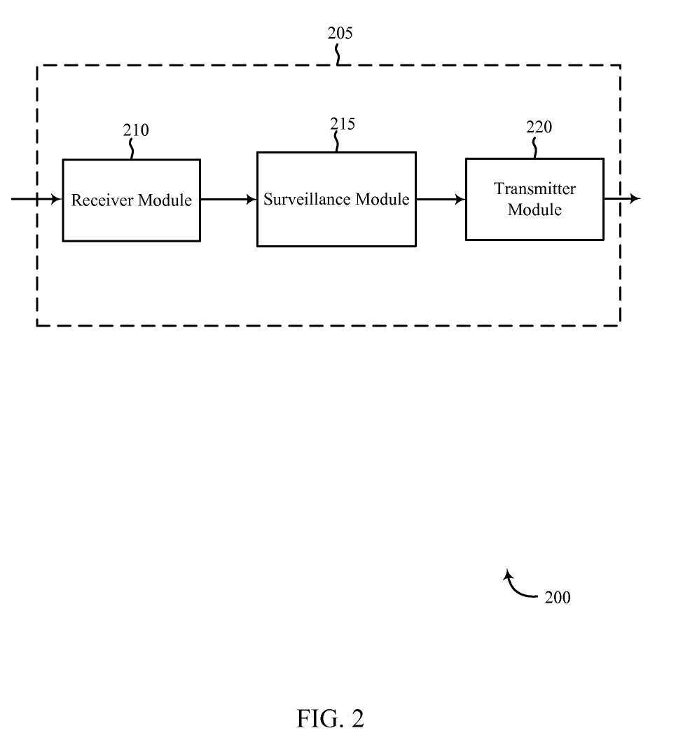

FIG. 2 shows a block diagram 200 of an example apparatus 205 for use in electronic communication, in accordance with various aspects of this disclosure. The apparatus 205 may be an example of one or more aspects of a control panel 130, or in other embodiments may be an example of one or more aspects of the one or more sensors 110, or in still other embodiments may be an example of one or more aspects of the computing devices 145 and/or 135, each of which are described with reference to FIG. 1. The apparatus 205 may include a receiver module 210, a surveillance module 215, and/or a transmitter module 220, among others. The apparatus 205 may also be or include a processor. Each of these modules may be in communication with each other—directly and/or indirectly.

In one embodiment, where apparatus 205 is a control panel, apparatus 205 may be a control panel in the form of an interactive home automation system display. In another embodiment, apparatus 205 may be a local computing device such as a personal computer or portable electronic device (e.g., smart phone, smart watch, tablet computer). In another embodiment, apparatus 205 may be at least one sensor 110.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). In one example embodiment, the sensors 110 may be cameras enabled to capture a plurality of image (still image and/or video) files. The sensors 110 may further comprise or be coupled to identification and/or location detecting elements, such as motion sensors, biometric readers, audio capture devices (e.g. a microphone), and the like. The receiver module 210 may be configured to receive audio and/or still image and/or video files from the sensors 110. Received audio and/or still image and/or video files may be passed on to a surveillance module 215, which may display at the apparatus 205 audio and/or still image and/or video files received from the receiver module 210. In addition, the surveillance module 215 may detect one or more types of data such as audio, still image, video, identification, location, and/or authentication, at the apparatus 205, and may communicate the detected data on a transmitter module 220, and to other components of the apparatus 205. The transmitter module 220 may then communicate the data to the remote computing device 135, the control panel 130, and/or server 115.

In one embodiment, where the apparatus 205 is a control panel, the transmitter module 220 may communicate video files, identification and/or location data to the remote computing device; for example, the transmitter may communicate that a person has been detected as located in a pre-determined location (e.g., a certain room, within a structure). In another embodiment, the transmitter may communicate the determined identification of the person. In yet another embodiment, the transmitter may send video files captured at any of a plurality of cameras coupled to the system. Surveillance module 215 may process information related to surveillance and/or video compositing. In one embodiment, a home environment may be contemplated, although the current description is not limited to a home environment and may be implemented in any other environment, for example, an outdoor location and/or a commercial location.

A plurality of cameras may be established inside and/or outside of the example house. For example, a camera may be located outside of the house in various locations and positioned to capture, for example, the front walkway, the entryway/porch, the front door, the garage, a side door, the back yard, and/or a back entrance. In addition, the inside of the house may also be furnished with a plurality of locations, for example, cameras may be located in each room of the house, including the living room, kitchen, dining room, each occupant's bedroom, an office, etc.

Regardless of how many cameras and/or the cameras' locations, each camera may record video inside and/or outside of the house. The videos may be recorded 24 hours a day or may be programmed to record at pre-determined times and for pre-determined lengths of time based on user preferences. Recording may be programmed to start and stop automatically, or recording may start and stop based on input from a user and/or input from one or more sensors 110 and/or other components of a system (e.g., communications system 100).

The cameras may send the video files to remote computing device 135, local computing device 145, server 115, a cloud storage location and/or may store the video files locally. As previously described, in some embodiments, the cameras may be collocated with any of the sensors 110 and/or with the control panel 130.

In one example embodiment, a camera may be programmed to begin recording when motion, heat, and/or sound is detected. For example, a camera outside of the house (e.g., a doorbell camera, a front entry camera, a backdoor camera, etc.), may individually determine, and/or may be coupled to a system that determines, that a person is within a capture range. The camera may begin recording and may continue recording until one or more conditions is met, such as the presence of the person being no longer detected. In some embodiments, the camera system may further determine whether or not the person is authorized to be at the house by way of one or more data sources, including, but not limited to, sensors. The sensors and/or other components may include, but are not limited to, determining identification by facial recognition, body (or body portion) recognition, physical characteristic recognition (e.g., height, weight, tattoos, hair color, hair style), voice recognition, an RFID tag, identification of a portable electronic device associated with a person, etc. In some embodiments, determining identification may be based on referencing one or more stored profiles and/or characteristics of occupant and/or those associated with a home automation system. For example, a system may receive input that a 6′ 4″ male has entered the home (based on height and/or voice recognition). The system may compare these features to those of the home occupants (among others) and determine that no male and/or no male of this size is authorized in the home and/or occupies the home. The system may take appropriate steps, as described in this disclosure, based at least in part on this identification.

If the person recorded is determined to be authorized, the camera may cease recording before the person leaves the area. If the person is determined to be unauthorized, the system may send an alert to a user of the system (e.g., the home owner) that a person has been detected and is being filmed. In one embodiment, the alert may indicate a person is suspected as having broken into the house or is located in an area that the person is not authorized to be located. If the person is determined to be authorized but is engaging in unauthorized behavior (based on sensor data and/or one or more determinations based on sensor data and/or tracking the actions of the person), the system may send an alert to a user of the system (e.g., the home owner) that a person has been detected and is being filmed. The system may request instructions from the user. In one embodiment, the user may receive a still image and/or a video clip of the person in order to make a personal determination as to authorization. For example, the user may determine that although the system may not have initially identified the person as being authorized, the user can see that the person on camera is his daughter, and thus the camera may stop recording. However, in another example, the user may determine that the person is in fact unauthorized, and request that the camera continue recording. In yet another embodiment, the camera continues recording regardless of any user input and/or user preferences. In some embodiments, the camera may initiate and/or perform one or more operations based at least in part on past user input, user preferences, and/or past initiated actions. For example, if a user has requested multiple times that the camera continue recording based on one or more specified inputs, it may automatically perform one or more operations based on this past action.

Subsequently, the person captured by the first camera may then enter a second location. For example, the unauthorized person may enter through the front door and into the living room. A camera located in the living may determine the presence of a person (e.g., by way of sensors) and begin recording. In another embodiment, the living room camera may have received an indication an unauthorized person was identified by a camera in a neighboring location (e.g., a neighboring room, a neighboring entryway), and thus began recording in anticipation of capturing video of the person. The recording of video (and/or other data) may continue by one or more sources as the person moves from room to room.

The system may then combine together the video files captured by the plurality of cameras, and may use additional data to link the videos together into a single composite video. For example, using timestamps and/or having an indication of which rooms (and thus which cameras and/or other sensors and/or components) are proximate one another, the system may create a composite video appending one video to another video. In some embodiments, this may be based on a known layout of the house/structure. In other embodiments, this may be based on more specific, situational input, such as identifying which of the multiple sensors received one or more types of input in a certain order on this occasion. In one embodiment, the composite video will illustrate the path taken by the person into and/or throughout the house.

The individual video (and/or other image-related) files and/or the composite video (and/or other image-related) file may be sent to the remote computing device 135, local computing device 145, server 115, the control panel 130 and/or may be stored in local and/or cloud memory.

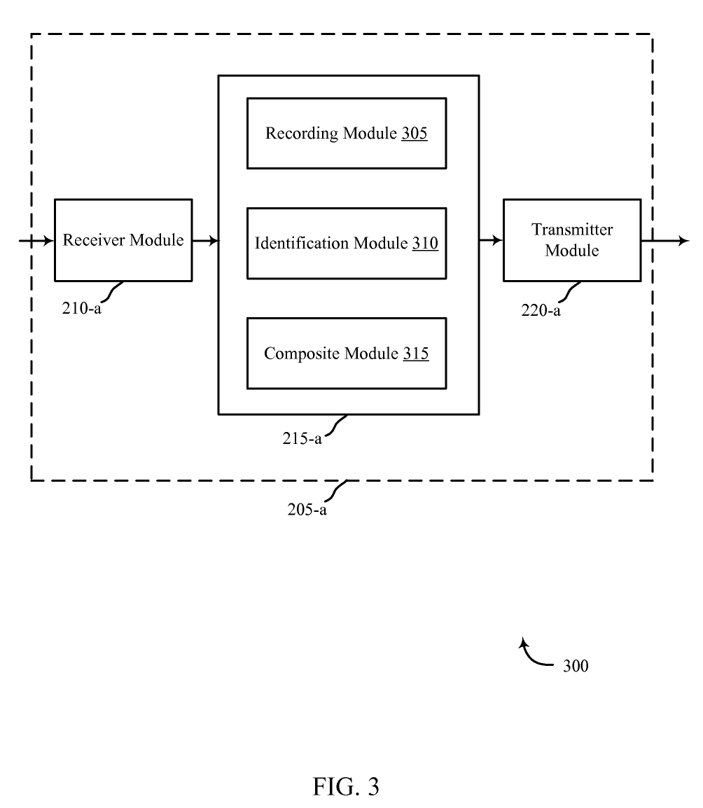

FIG. 3 shows apparatus 205-a, which may be an example of apparatus 205 illustrated in FIG. 2, among others, in accordance with at least some embodiments. Apparatus 205-a, may comprise any of a receiver module 210-a, a surveillance module 215-a, and/or a transmitter module 220-a, each of which may be examples of the receiver module 210, the surveillance module 215, and the transmitter module 220 as illustrated in FIG. 2. Apparatus 205-a may further comprise, as a component of the surveillance module 215-a, any of a recording module 305, an identification module 310, and/or a composite module 315.

The components of apparatus 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

In one embodiment, recording module 305 may enable which cameras and/or other sensors are activated to record and/or capture data, when the cameras and/or other sensors are activated, and/or for how long, among other operations. For example, recording module 305 may enable the garage camera to begin recording still images and/or video upon detection of movement and cease recording upon receiving an indication from the home owner that further recording is not necessary. In another embodiment, recording module 305 may enable communications between different cameras to indicate that one camera should start recording in anticipation of a person entering a room. This anticipation may be based at least in part on data received from one or more sensors, including image and/or location data, and performing one or more determinations relating to movement, such as determining direction and speed of a person in relation to one or more areas, among other things. Recording module 305 may also enable communications between different elements of the system (e.g., cameras, control panel, computing systems) to capture video and/or still image recordings of people, among other things.

In one embodiment, identification module 310 may enable detection of the presence of and/or identification of a person by way of one or more sensors, including sensors which capture biometric information. The biometric identification captured may include determining the identity of a person by way of identifying the location of a user's portable electronic device through one or more location-based methods, such as GPS, infrared, Bluetooth, triangulation, etc. The identification data received by the identification module 310 may be communicated to transmitter module 220-a, which may communicate the data to the remote computing device. In addition, the identification module 310 may comprise and/or receive data from one or more of a motion sensor, a retinal scanner, a fingerprint scanner, a voiceprint sensor, a camera calibrated to identify facial structure, a GPS receiver or a input device (e.g. a keypad) into which a user may input a PIN or any other known identification detection means to detect the presence of a user and to determine the user's identity at or near any of the plurality of cameras, sensors, and/or other system components.

In some embodiments, identification and location data may be detected continuously at apparatus 205-a or at predetermined times and intervals. In other embodiments, identification and location data may be detected at apparatus 205-a at the instruction of a user. In some embodiments, the collected identification and location data may be communicated by way of transmitter module 220-a in real-time to the processor or remote computing device, while in other embodiments, the collected identification and/or location data may be time stamped and stored in memory integrated with the apparatus 205-a, stored in the network 120, and/or stored on the server 115 (as shown in FIG. 1).

In addition, identification module 310 may not only determine the identity of a person, but may also make a determination as to whether the person is authorized to be in certain locations or in the house at all. For example, it may be the case that a babysitter may be able to spend time in any of the rooms of a house except for the office or a parent's bedroom. In another embodiment, the babysitter may be allowed in any room in and around the house, but only between the hours of 5:00 p.m. and 11:00 p.m. The identification module 310 may thus determine the identity and the authorization of a person, and subsequently communicate the information to the recording module 305, the composite module 315, and/or the transmitter module 220-a.

In one embodiment, composite module 315 may be enabled to receive a plurality of video files and/or related data and combine the video files into a single composite video. In one example, the composite module 315 may receive data in the form of timestamps associated with the plurality of video files, such that the composite module 315 is enabled to splice and/or append the ending of one video to the beginning of another video, so that the videos are appended in a contiguous timeline. In other examples, the composite module 315 may receive different data and/or user instructions to create the composite video. The composite module 315 may communicate with other elements of the system, and may send the composited file to a user by way of wireless or wired communication protocols. For example, the composite module 315 may send the composite video file to a remote computing device 135, a local computing device 145, a server 115, the control panel 130, and/or a local and/or cloud storage.

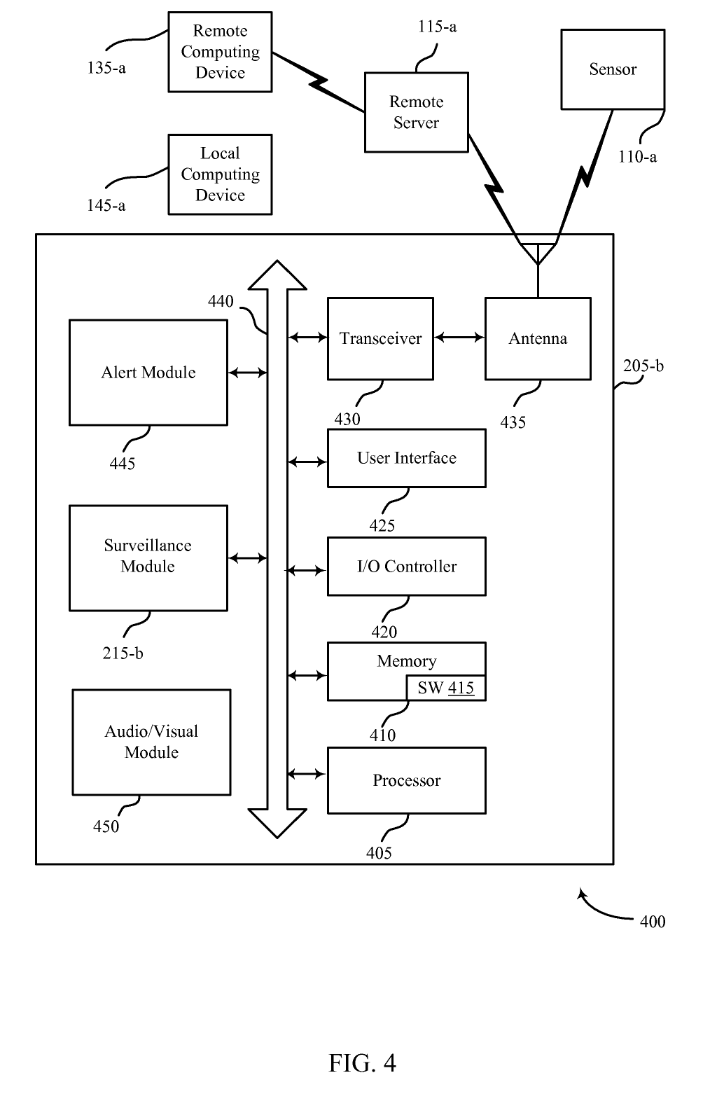

FIG. 4 shows a system 400 for use in video splicing in accordance with at least some embodiments. System 400 may include an apparatus 205-b, which may be an example of the control panel 130, remote computing device 135, local computing device 145, and/or one or more sensors 110 of FIG. 1, among others. Apparatus 205-b may also be an example of one or more aspects of apparatus 205 and/or 205-a of FIGS. 2 and 3.

Apparatus 205-b may include a surveillance module 215-b, which may be an example of the surveillance module 215, 215-a described with reference to FIGS. 2 and 3. The surveillance module 215-b may enable identification of people in and around a pre-determined location, capturing of video files at a plurality of cameras located in and around the pre-determined location, and combining a plurality of video files into one continuous video files, as described above with reference to FIGS. 2-3.

Apparatus 205-b may also include components for bi-directional voice and data communications including components for transmitting communications and components for receiving communications. For example, apparatus 205-b may communicate bi-directionally with remote computing device 135-a, remote server 115-a, or sensor 110-a. This bi-directional communication may be direct (e.g., apparatus 205-b communicating directly with sensor 110-a) or indirect (e.g., apparatus 205-b communicating with remote computing device 135-a via remote server 115-a). Remote server 115-a, remote computing device 135-a, local computing device 145-a and sensor 110-a may be examples of remote server 115, remote computing device 135, local computing device 145, and sensor 110 as shown with respect to FIG. 1.

In addition, apparatus 205-b may comprise alert module 445 and audio/visual module 450. Alert module 445 may be part of surveillance module 215-b, or may be a separate and distinct alert module. Alert module 445 may be operable to determine whether the presence of a specific person in a specific location is and/or should be associated with an alert event. For example, if a person captured by a video recording is determined to be unidentified, unidentifiable, and/or unauthorized, alert module 445 may send a notification to a remote user regarding the presence of the person and/or proposing initiating one or more operations. In some embodiments, the remote user may receive a notification that the person is unidentified, unidentifiable, and/or unauthorized, and may be asked to make a decision about how to proceed; for example, whether the video system should continue to capture videos and/or combine the video files into a single video file. In other examples, the alert module 445 may determine the person is unauthorized and may issue an audio and/or video alert to the person indicating a request of the person to remove themselves from the premise. In yet another embodiment, the alert module 445 may send a communication to an emergency service, such as a police department. In another embodiment, the alert may activate a security system, or change the settings of a security system. In yet still another embodiment, the alert module 445 may determine that, based on the situation, the system should automatically continue or cease video recording. In yet still other embodiments, the alert may be a visual (e.g., flashing light) or audio (e.g., loud sound) alert which is set off to startle the unauthorized person.

In addition, apparatus 205-b may comprise an audio/visual module 450. Audio/visual module 450 may comprise a microphone, speaker, and/or camera, among other elements. Thus, the remote computing device 135-a and/or local computing device 145-a and/or server 115-a may be able to establish one-way or two-way communication with one or more apparatuses 205-b throughout the home or property based, at least in part, on the location of each apparatus 205-b. Further, using video, image, identification and/or location data collected from surveillance module 215-b, the remote computing device 135-a, local computing device 145-a, and/or server 115-a may be able to establish one-way or two-way communication with one or more apparatuses 205-b based, at least in part, on detected user identification and location.

In some embodiments, one-way or two-way communication may be established based on data received from more than one apparatus 205-b. For example, a first apparatus, such as the apparatus 205-b, may collect and communicate audio/visual data by way of surveillance module 215-b to the remote computing device 135-a and/or local computing device 145-a. However, the first apparatus 205-b may not have a speaker, microphone, and/or camera unit. Thus, one-way or two-way communication may be established between the remote computing device 135-a and/or local computing device 145-a and/or a second apparatus located near the first apparatus 205-b based on location information received from the surveillance module 215-b in each of the first and second apparatuses. In this way, one- or two-way communication may be established with the remote computing device 135-a and/or the local computing device 145-a via the apparatus having a speaker, microphone, and/or camera unit that is located most closely to the detected audio and/or user identification and location data.

Apparatus 205-b may also include a processor module 405, and memory 410 (including software (SW) 415), an input/output controller module 420, a user interface module 425, a transceiver module 430, and one or more antennas 435, each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of remote server 115-a or sensor 110-a. The transceiver module 430 may include a modem to modulate the packets and provide the modulated packets to the one or more antennas 435 for transmission, and to demodulate packets received from the one or more antennas 435. While an apparatus comprising a sensor, local computing device, or control panel (e.g., 205-b) may include a single antenna 435, the apparatus may also have multiple antennas 435 capable of concurrently transmitting or receiving multiple wired and/or wireless transmissions. In some embodiments, one element of apparatus 205-b (e.g., one or more antennas 435, transceiver module 430, etc.) may provide a direct connection to a remote server 115-a via a direct network link to the Internet via a POP (point of presence). In some embodiments, one element of apparatus 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z Wave, cellular network (using 3G and/or LTE, for example), and/or other signals. The one or more antennas 435 and/or transceiver module 430 may include or be related to, but are not limited to, WWAN (GSM, CDMA, and WCDMA), WLAN (including Bluetooth and Wi-Fi), WMAN (WiMAX), antennas for mobile communications, antennas for Wireless Personal Area Network (WPAN) applications (including RFID and UWB). In some embodiments each antenna 435 may receive signals or information specific and/or exclusive to itself. In other embodiments each antenna 435 may receive signals or information neither specific nor exclusive to itself.

In some embodiments, one or more sensors 110-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, a visual device such as a camera or video camera, an external display device such as a display screen, and/or an input device (e.g., remote control device interfaced with the user interface module 425 directly and/or through input/output controller module 420).

One or more buses 440 may allow data communication between one or more elements of apparatus 205-b (e.g., processor module 405, memory 410, input/output controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., detect identification and/or location data, make one or more determinations based on identification and/or location data, broadcast audio communications from the remote computing device, etc.). Alternatively, the computer-executable software/firmware code 415 may not be directly executable by the processor module 405 but may cause a computer (e.g., when compiled and executed) to perform functions described herein.

In some embodiments the processor module 405 may include, among other things, an intelligent hardware device (e.g., a central processing unit (CPU), a microcontroller, and/or an ASIC, etc.). The memory 410 may contain, among other things, the Basic Input-Output system (BIOS) which may control basic hardware and/or software operation such as the interaction with peripheral components or devices. For example, the surveillance module 215-b may be stored within the memory 410. Applications resident with system 400 are generally stored on and accessed via a non-transitory computer readable medium, such as a hard disk drive or other storage medium. Additionally, applications may be in the form of electronic signals modulated in accordance with the application and data communication technology when accessed via a network interface (e.g., transceiver module 430, one or more antennas 435, etc.).

Many other devices and/or subsystems may be connected to, or may be included as, one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and is not discussed in detail in this disclosure. Code to implement the present disclosure may be stored in a non-transitory computer-readable medium such as one or more of memory 410 or other memory. The operating system provided on input/output controller module 420 may be iOS®, ANDROID®, MS-DOS®, MS-WINDOWS®, OS/2®, UNIX®, LINUX®, or another known operating system.

The components of the apparatus 205-b may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

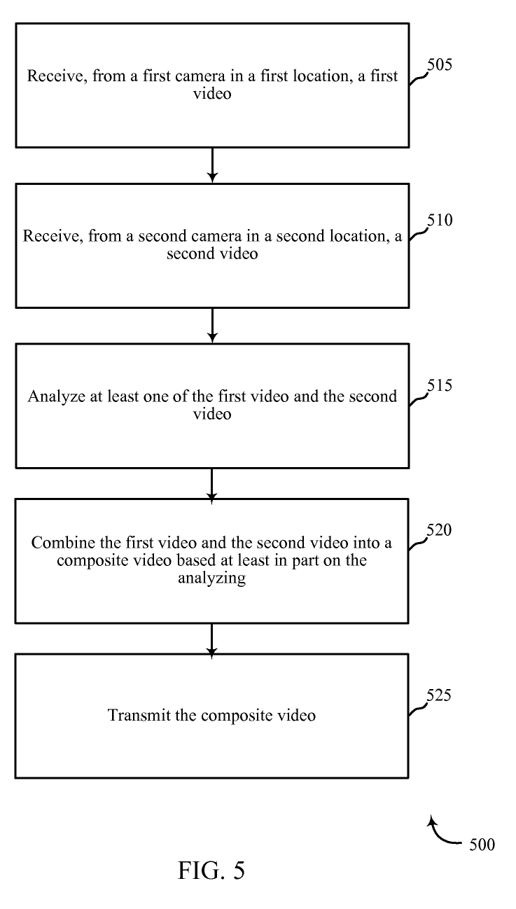

FIG. 5 is a flow chart illustrating an example of a method 500 for image compositing (e.g., video), in accordance with at least some embodiments. For clarity, the method 500 is described below with reference to aspects of one or more of the sensors 110, local computing device 145, control panel 130, and/or remote computing device 135 as described with reference to FIGS. 1-4. In addition, method 500 is described below with reference to aspects of one or more of the apparatus 205, 205-a, or 205-b described with reference to FIGS. 2-4. In some examples, a control panel, local computing device, and/or sensor may execute one or more sets of codes to control the functional elements described below. Additionally or alternatively, the control panel, local computing device, and/or sensor may perform one or more of the functions described below using special-purpose hardware.

At block 505, the method 500 may include receiving, from a first camera in a first location, a first video. The first video may be received based on information determined by and/or received by surveillance module 215 as described with reference to FIG. 2. The first video may be captured and/or received from one or more sensors and/or other components. At block 510, the method 500 may include receiving, from a second camera in a second location, a second video. As with block 505, the second video may be received based on information determined by or received by surveillance module 215. The second video may be captured and/or received from one or more sensors and/or other components.

At block 515, the method 500 may include analyzing at least one of the first video and the second video. In some embodiments, analyzing at least one of the first video and the second video may include determining the presence of a person in at least one of the videos, identifying the person (e.g., by way of facial structure, voice print, retinal scanning, etc.), determining one or more physical characteristics of one or more persons (e.g., height, weight, build, hair color, hair style, tattoos, etc.), actively and/or passively tracking movement using sensors and/or other components, predicting person movement based on current movement and/or characteristics (e.g., speed, gait, height, noise level, light/darkness, time of day, etc.) and determining an action to take based on the determining (e.g., sounding an alarm, turning on automated lights and/or appliances and/or devices, alerting a user associated with an automation system). For example, if the person is authorized to be at the location at a specific time, the method may cease and/or perform only secondary operations. In other embodiments, if the person is determined to be unauthorized and/or unidentified, the method may record multiple videos of the person in multiple locations and/or initiate one or more operations based on the one or more determinations.

At block 520, the method 500 may include combining the first video and the second video into a composite video based at least in part on the analyzing, among other things. In some embodiments, combining the first video and the second video into a composite video is the result of determining a person is not authorized to be in a specific location. Thus, the video files are combined into a single composite video which may show the progress of the person from location to location in a series of sequential time frames. In one embodiment, combining the video may comprise splicing the video files together. In another embodiment, combining the video files may include determining when a person is facing the camera and combining only the portions of the video files when the person's face or profile can be seen. In yet another embodiment, combining the video files may combine the portions of the video files where the person is shown on screen, as opposed to times when they are potentially located in the room but not shown on the video (e.g., behind a couch, behind a pillar). In some embodiments, the combining may be automatic based on determining the person is authorized. In other embodiments, combining may be enabled based on user input.

At block 525, the method may include transmitting the video. In some embodiments, the video may be transmitted to a remote computing device 135 and/or a local computing device 145, among others. In other embodiments, the video may be transmitted to a remote server 115 for storage or other transmission.

The operations at blocks 505, 510, 515, 520, and 525 may be performed using the receiver module 210, 210-a, the surveillance module 215, 215-a, 215-b, the transmitter module 220, 220-a, and/or the transceiver module 430, described with reference to FIGS. 2-4, among others.

Thus, the method 500 may provide for image compositing in accordance with at least some embodiments. It should be noted that the method 500 is just one implementation and that the operations of the method 500 may be rearranged or otherwise modified such that other implementations are possible.

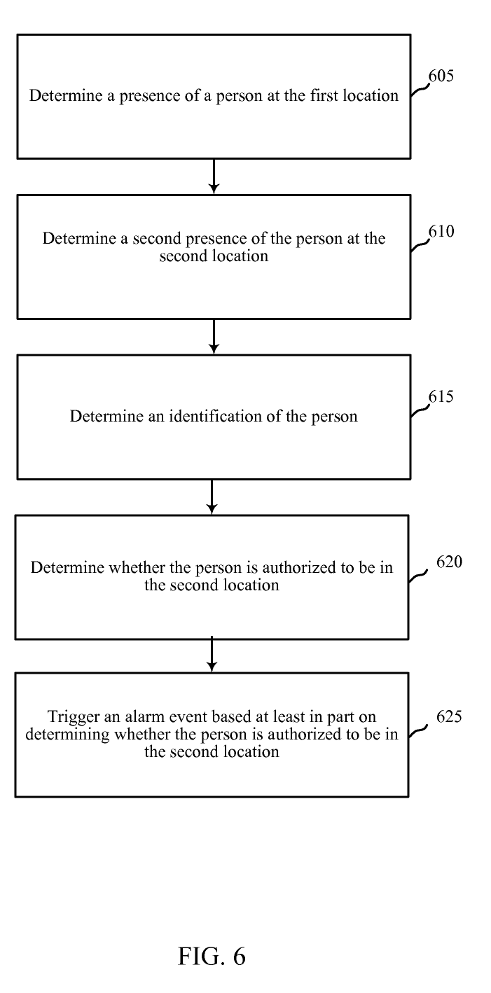

FIG. 6 is a flowchart illustrating an example of a method 600 for image compositing (e.g., video) in accordance with at least some embodiments. For clarity, the method 600 is described below with reference to aspects of one or more of the sensors 110, remote computing device 135, local computing device 145, and/or control panel 130, described with reference to FIGS. 1-4, and/or aspects of one or more of the apparatus 205, 205-a, or 205-b described with reference to FIGS. 2-4. In some examples, a control panel, local computing device, and/or sensor may execute one or more sets of codes to control the functional elements described below. Additionally or alternatively, the control panel, local computing device, and/or sensor may perform one or more of the functions described below using special-purpose hardware.

At block 605, method 600 may include determining a presence of a person at a first location. For example, a camera located in the living room of a home may be enabled to capture of field of view that includes the living room. A system associated with the camera determines the presence of a person located in the living room. For purposes of this example, the person may be a babysitter and/or other invited guest. The presence of the person may be determined by way of a motion detector, an audio detector, and/or by other means.

At block 610, method 600 may include determining a second presence of the person at a second location. For example, a camera located in the master bedroom (which may adjoin the living room) may be enabled to capture of field of view that includes the interior of the master bedroom and/or the entryway of the master bedroom. A system associated with the camera may determine the person (e.g., the babysitter) has entered the master bedroom.

At block 615, method 600 may determine the identification of the person, as described more thoroughly later in the discussion. Although block 615 is indicated to come after block 610 in sequence, the actions of block 610 may occur after block 605 or at some other time and/or sequence. At block 620, method 600 may determine whether the person is authorized to be in the second location. At block 625, the method 600 may trigger an alarm event and/or other notification based at least in part on determining whether the person is authorized to be in the second location.

Authorization may be determined based on one or more variables. In one embodiment, authorized persons may include family members and frequent family guests to a home. In this embodiment, the authorized group of persons may be authorized every day of the year, 24 hours a day. In another embodiment, a group of people may be authorized, but may only be authorized to be in specific rooms and/or at specific times. For example, the parents living in a home may be authorized to be outside at all times of day, as well as inside every room regardless of the time. A teenage son, however, may be authorized to be in the front, outside entry before midnight, but should not be leaving the house after midnight. Thus, if the son is identified as being located outside after midnight, an alarm event and/or notification event may be triggered. In another embodiment, a babysitter may be authorized to be in the home in all rooms except for the master bedroom during the times he or she is watching the children. In this example embodiment, the parents may program the system based on the babysitter's expected schedule and/or duties. In another embodiment, a cleaning service may be authorized to be in the home in all rooms except for the office during the times he or she is cleaning the house or the office. In this example embodiment, the parents may program the system based on the cleaning service's expected schedule and/or duties.

In the case a person is determined not to be authorized to be in the location, the alarm event may be to indicate to the surveillance system to begin or to continue recording video files at some or all of the video cameras associated with the system. In another embodiment, the alarm event for an unauthorized person may be to communicate with a user (e.g., the home owner) and request subsequent steps. For example, the system may send a video clip or still image to the user to make a determination as to whether to begin or to continue recording video files. In another embodiment, the alarm event may be to communicate with emergency services, such as the police. In yet another embodiment, the alarm event may be to communicate to the unauthorized person that the person is unauthorized and should leave the area. If there are multiple videos recorded, the system may combine the video files together into a single composite video. In the case the person is determined to be authorized, the system may still continue to record video.

The operations at blocks 605, 610, 615, 620, and 625 may be performed using the receiver module 210, 210-a, the surveillance module 215, 215-a, 215-b, the transmitter module 220, 220-a, and/or the transceiver module 430, described with reference to FIGS. 2-4, among others.

Thus, the method 600 may provide for image compositing in accordance with at least some embodiments. It should be noted that the method 600 is just one implementation and that the operations of the method 600 may be rearranged or otherwise modified such that other implementations are possible.

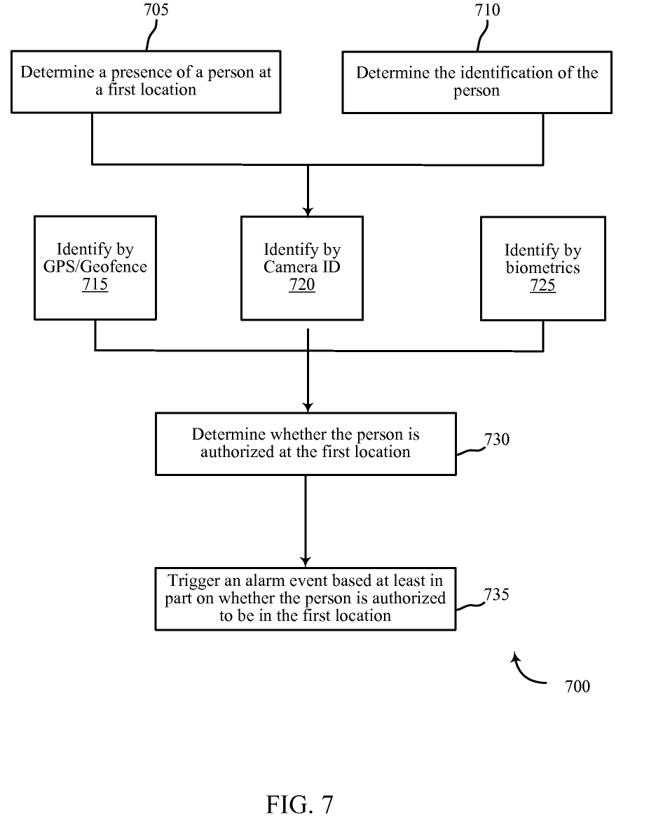

FIG. 7 is a flowchart illustrating an example of a method 700 for image compositing (e.g., video) in accordance with at least some embodiments. For clarity, the method 700 is described below with reference to aspects of one or more of the sensors 110, remote computing device 135, local computing device 145, and/or control panel 130, described with reference to FIGS. 1-4, and/or aspects of one or more of the apparatus 205, 205-a, or 205-b described with reference to FIGS. 2-4. In some examples, a control panel, local computing device, and/or sensor may execute one or more sets of codes to control the functional elements described below. Additionally or alternatively, the control panel, local computing device, and/or sensor may perform one or more of the functions described below using special-purpose hardware.

At block 705, method 700 may include determining a presence of a person at a first location. Before, after, or simultaneously with determining the presence of the person at the first location, the method may include determining the identification of the person, as in block 710. In one embodiment, the presence of a person may be determined by way of a pre-determined virtual outline, for example, a geo-fence may be established around pre-determined locations outside or and within a home, as shown in block 715. A person may have associated with them a smartphone, radio-frequency identification (RFID) tag, wearable device, or other implement which communicates wirelessly with a global positioning system. When the location of the smartphone or smartwatch is determined to be located within an established geo-fence, the system may determine the presence of the person at the location associated with the geo-fence location. In another embodiment, as shown by block 720, the presence of the person may be determined by way of a motion sensor and/or an audio detector (e.g., a microphone), and the location may be determined by associating the detected motion and/or sound with a camera having an identification number.

In block 725, the method 700 determines the identification of the person at the first location. As previously discussed, identification may be captured by at least one of a plurality of sensors, control panels, or local computing devices, or a combination thereof, positioned throughout the home and/or carried by the occupant. In one embodiment, identifying the occupant and the occupant's location may be determined by capturing biometric information. A plurality of identification means may be contemplated, such as by way of voice identification by way of a microphone enabled to capture audio from the person, and facial identification by way of software executing on a camera system, among other methods discussed and/or contemplated by the present disclosure. The methods described in blocks 715, 720, and 725 may be performed concurrently, in series, in parallel, individually, and/or any combination thereof.

In block 730, the method 700 may include determining whether the person identified at the first location is authorized to be at the location. For each of the identification means, a previously populated database of authorized people may be provided for comparison. Thus, each person authorized to be located in the home, or located in specific rooms within the home, or located within specific rooms at specific times, may have a profile stored in memory which comprises a voice print, and/or a facial scan or other identifying information. At block 730, the method 700 compares the identification and location information determined in blocks 705 and 710 and compares the data to the database of authorized profiles. In some embodiments, the database may be populated with the newly acquired identification information, and the profiles of the people identified updated by a user at a later date. In block 735, the method 700 may include trigger an alarm event based at least in part on whether the person is authorized to be in the first location.

Thus, the method 700 may provide for image compositing in accordance with at least some embodiments. It should be noted that the method 700 is just one implementation and that the operations of the method 700 may be rearranged or otherwise modified such that other implementations are possible.

In some examples, aspects from two or more of the methods 500, 600, and 700 may be combined and/or separated. It should be noted that the methods 500, 600, and 700 are just example implementations, and that the operations of the methods 500, 600, and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. This disclosure may specifically apply to communication system applications. In some embodiments, the concepts, the technical descriptions, the features, the methods, the ideas, and/or the descriptions may specifically apply to security and/or automation and/or communication system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for automation and/or security comprising:
receiving, from a first camera in a first location, a first video;
receiving, from a second camera in a second location, a second video;
analyzing at least one of the first video and the second video;
combining the first video and the second video into a composite video based at least in part on the analyzing; and
transmitting the composite video.

2. The method of claim 1, wherein transmitting further comprises:
transmitting the composite video to a handheld wireless device.

3. The method of claim 2, further comprising:
identifying an alarm status; and
modifying the alarm status based at least in part on the alarm status and determining whether a person is authorized.

4. The method of claim 1, further comprising:
determining a first presence of a person at the first location;
determining a second presence of the person at the second location;
determining an identification of the person;
determining whether the person is authorized to be in the second location; and
triggering an alarm event based at least in part on determining if the person is authorized to be in the second location.

5. The method of claim 1, further comprising:
determining a presence of a person at the first location;
determining whether the person is authorized to be in the first location; and
requesting approval from a user to perform an operation based at least in part on determining the person is unauthorized to be in the first location.

6. The method of claim 5, wherein determining whether the person is authorized comprises:
capturing biometric information associated with the person; and
analyzing the captured biometric information.

7. The method of claim 6, further comprising:
determining a time of day; and
determining whether the person is authorized to be at the first location, the determining based at least in part on the time of day.

8. The method of claim 5, wherein determining whether the person is authorized comprises:
capturing biometric information associated with the person; and
comparing the captured biometric information to a database of authorized people.

9. The method of claim 8, wherein capturing biometric information comprises:
capturing at least one of voice recognition, or facial recognition, or radio frequency identification recognition, or retinal recognition, or fingerprint recognition, or a combination thereof.

10. The method of claim 1, wherein analyzing further comprises:
determining a relationship between the first location and the second location; and
determining that a person has exited the first location and entered the second location.

11. The method of claim 1, wherein combining further comprises:
appending a beginning of the second video to an ending of the first video.

12. The method of claim 1, further comprising:
receiving, from a third camera in a third location, a third video, the third location being in outdoor environment; and
combining the third video with the composite video.

13. An apparatus for automation and/or security comprising:
a processor;
memory in electronic communication with the processor;
a wireless communication interface coupled to the processor;
instructions stored in the memory, the instructions cause the processor to:
receive, from a first camera in a first location, a first video;
receive, from a second camera in a second location, a second video;
analyzing at least one of the first video and the second video;
combining the first video and the second video into a composite video based at least in part on the analyzing; and
transmitting the composite video.

14. The apparatus of claim 13, wherein when the processor transmits, the instructions further cause the processor to:
transmit the composite video to a handheld wireless device.

15. The apparatus of claim 14, wherein the instructions further cause the processor to:
identify an alarm status; and
modify the alarm status based at least in part on the alarm status and determining whether a person is authorized.

16. The apparatus of claim 13, wherein the instructions further cause the processor to:
determine a first presence of a person at the first location;
determine a second presence of the person at the second location;
determine an identification of the person;
determine whether the person is authorized to be in the second location; and
trigger an alarm event based at least in part on determining if the person is authorized to be in the second location.

17. The apparatus of claim 13, wherein the instructions further cause the processor to:
determine a presence of a person at the first location;
determine whether the person is authorized to be in the first location; and
request approval from a user to perform an operation based at least in part on determining the person is unauthorized to be in the first location.

18. The apparatus of claim 17, wherein when the processor determines whether the person is authorized, the instructions further causes the processor to:
capture biometric information associated with the person; and
analyze the captured biometric information.

19. The apparatus of claim 18, wherein the instructions further cause the processor to:
determine a time of day; and
determine whether the person is authorized to be at the first location, the determining based at least in part on the time of day.

20. A non-transitory computer-readable medium storing a program that, when executed by a processor, causes the processor to:
receive, from a first camera in a first location, a first video;
receive, from a second camera in a second location, a second video;
analyze at least one of the first video and the second video;
combine the first video and the second video into a composite video based at least in part on the analyzing; and
transmit the composite video.
